(19) United States
(12) Patent Application Publication
(10) Pub. No.: US 2026/0171784 A1
(43) Pub. Date: Jun. 18, 2026

(54) HARDWARE LOGIC TO PROTECT POWER ELECTRONICS COMPONENTS

(71) Applicant: Cummins Power Generation Inc., Minneapolis, MN (US)

(72) Inventors: Latif M. Shaikh, Pune (IN); Anand Narayan Jarudkar, Pune (IN)

(73) Assignee: Cummins Power Generation Inc., Minneapolis, MN (US)

(21) Appl. No.: 19/128,514

(22) PCT Filed: Nov. 10, 2023
(86) PCT No.: PCT/US2023/079425

§ 371 Date: May 8, 2025

(30) Foreign Application Priority Data
Nov. 11, 2022 (IN) 202241064561

(51) Int. Cl. H02H 7/18; H02H 3/06

(52) U.S. Cl. CPC H02H 7/18; H02H 3/06

(57) ABSTRACT

Systems and apparatuses include one or more processing circuits comprising one or more memory devices coupled to one or more processors, the one or more memory devices configured to store instructions thereon that, when executed by the one or more processors, cause the one or more processors to: monitor power electronics parameters; compare the parameters to a hardware protection threshold; activate software protection of the power electronics when the parameters are less than the hardware protection threshold; and activate hardware protection logic of the power electronics when the parameters are greater than or equal to the hardware protection threshold.

### CROSS REFERENCE TO RELATED APPLICATIONS

The present application claims the benefit of priority to Indian Provisional Patent Application No. 202241064561, titled “Hardware Logic to Protect Power Electronics Components,” filed Nov. 11, 2022, which is incorporated by reference in its entirety.

### BACKGROUND

The present disclosure relates generally to power electronics protection systems. More specifically, the present disclosure relates to power electronics protection systems for hotel load converters used in railway applications.

### SUMMARY

One embodiment relates to a power electronics protection system that includes one or more processing circuits comprising one or more memory devices coupled to one or more processors, the one or more memory devices configured to store instructions thereon that, when executed by the one or more processors, cause the one or more processors to: monitor power electronics parameters; compare the parameters to a hardware protection threshold; activate software protection of the power electronics when the parameters are less than the hardware protection threshold; and activate hardware protection logic of the power electronics when the parameters are greater than or equal to the hardware protection threshold.

At least one aspect of the present disclosure is directed to a system for hardware protection in power electronics. The system may include a hotel load converter (HLC) comprising a power electronic component configured to perform alternating current to alternating current to alternating current (AC/AC) conversion on electric power to provide to a load on a railway car. The system may include a controller structured to be coupled with the HLC. The controller may include a protection circuit. The controller may monitor a parameter of the power electronic component of the HLC. The controller may determine that the parameter fails to satisfy a normal threshold defining a first limit for the parameter corresponding to no fault condition in the power electronic component. The controller may determine that the parameter fails to satisfy a hardware threshold defining a second limit for the parameter corresponding to prior to failure of the power electronic component. The controller may activate hardware protection for the power electronic component of the HLC, responsive to determining that the parameter fails to satisfy the normal threshold and the hardware threshold,

In some embodiments, the controller may start a timer, responsive to determining that the parameter satisfies the hardware threshold. The controller may activate software protection for the power electronic component of the HLC, while the timer is below a time threshold. In some embodiments, the controller may start a timer while software protection is activated for the power electronic component, responsive to determining that the parameter satisfies the hardware threshold. In some embodiments, the controller may activate the hardware protection, responsive to the timer exceeding a time threshold for the software protection.

In some embodiments, the controller may activate the hardware protection by disconnecting or interrupting the power electronic component of the HLC for a period of time. In some embodiments, the controller may continue to monitor the parameter of the power electronic component of the HLC, responsive to determining that the parameter satisfies the normal threshold. In some embodiments, the controller may receive the electric power delivered via a pantograph from a contact wire from outside the railway car. In some embodiments, the controller may provide the electric power to the load on the railway car. The load may include at least one of: an entertainment system, a kitchen appliance, a refrigeration system, or a heating system for the railway car.

At least one aspect of the present disclosure is directed to a controller. The controller may include protection circuit comprising one or more processors coupled with memory. The protection circuit may monitor a parameter of a power electronic component of a hotel load converter (HLC) conveying electric power from outside a railway car to a load within the railway car. The protection circuit may compare the parameter of the power electronic component with a normal threshold to identify an existence of a fault condition. The protection circuit may compare the parameter of the power electronic component with a hardware threshold. The protection circuit may activate at least one of software protection or hardware protection for the power electronic component of the HLC, based on a comparison between the parameter with the normal threshold and a comparison between the parameter with the hardware threshold.

In some embodiments, the protection circuit may monitor a plurality of parameters comprising at least one of: a voltage, a current, or a frequency of the electric power conveyed through the HLC. In some embodiments, the protection circuit may compare the plurality of parameters with a corresponding plurality of thresholds to determine whether to activate one of the software protection or the hardware protection.

In some embodiments, the protection circuit may activate a counter, responsive to determining that the parameter satisfies the hardware threshold. In some embodiments, the activate the software protection for the power electronic component of the converter, while a value of the counter is less than a software protection threshold.

In some embodiments, the protection circuit may activate a counter while software protection is activated for the power electronic component, responsive to determining that the parameter satisfies the hardware threshold. In some embodiments, the protection circuit may switch from the software protection to the hardware protection, responsive to a value of the counter exceeding a software protection threshold.

In some embodiments, the protection circuit may identify a lack of abnormal operating condition in the power electronic component of the HLC, responsive to determining that the parameter satisfies the normal threshold. In some embodiments, the protection circuit may continue to monitor the parameter of the power electronic component, in response to identifying the lack of abnormal operating condition.

In some embodiments, the protection circuit may identify the existence of abnormal operating condition in the power electronic component of the HLC, responsive to determining that the parameter fails to satisfy the normal threshold. In some embodiments, the protection circuit may determine whether to activate one of the one of the software protection or the hardware protection based on a severity of the abnormal operating condition. In some embodiments, the one or more processors and memory of the protection circuit may be disposed in the railway car with the HLC.

At least one aspect of the present disclosure is directed to a method of protecting in power electronics. The method may include monitoring, by a controller, a parameter of a power electronic component of a hotel load converter (HLC). The method may include determining, by the controller, that the parameter fails to satisfy a normal threshold for the parameter corresponding to no fault condition in the power electronic component. The method may include determining, by the controller, that the parameter fails to satisfy a hardware threshold for the parameter corresponding to prior to failure of the power electronic component. The method may include activating, by the controller, hardware protection for the power electronic component of the HLC, responsive to determining that the parameter fails to satisfy the normal threshold and the hardware threshold.

In some embodiments, the method may include activating, by the controller, software protection for the power electronic component of the HLC, responsive to determining that the parameter fails to satisfy the normal threshold. In some embodiments, the method may include monitoring, by the controller, a second parameter of the power electronic component, while software protection is activated for the power electronic component. In some embodiments, the method may include deactivating, by the controller, the software protection, responsive to the second parameter satisfying the normal threshold within a time threshold.

In some embodiments, the method may include monitoring, by the controller, a second parameter of the power electronic component, while software protection is activated for the power electronic component. In some embodiments, activating the hardware protection may include switching from software protection to the hardware protection, responsive to the second parameter failing to satisfy the hardware threshold within a time threshold.

In some embodiments, the method may include maintaining, by the controller, activation of the software protection for the power electronic component of the HLC, while the hardware protection is deactivated. In some embodiments, the method may include determining, by the controller, that a an urgency of addressing an abnormal operating condition in the power electronic of the HLC satisfies a condition to activate the hardware protection. In some embodiments, the method may include activating the hardware protection further comprises activating the hardware protection for the power electronic component of the HLC, responsive to determining that the urgency of addressing the abnormal operating condition satisfies the condition.

In some embodiments, the method may include monitoring, by the controller, a second parameter of the power electronic component, while the hardware protection is activated. In some embodiments, the method may include switching, by the controller, from the hardware protection to software protection for the power electronic component of the HLC responsive to determining that the second parameter satisfies the normal threshold and the hardware threshold.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a railcar including a pantograph and a hotel load converter, according to some embodiments.

FIG. 2 is a perspective view of the hotel load converter of FIG. 1, according to some embodiments.

FIG. 3 is an exploded view of the hotel load converter of FIG. 1, according to some embodiments.

FIG. 4 is a schematic diagram of the hotel load converter of FIG. 1, according to some embodiments.

FIG. 5 is a schematic diagram of a controller of the hotel load converter of FIG. 1, according to some embodiments.

FIGS. 6A-C is a flow diagram of a method of operating the controller of FIG. 5, according to some embodiments.

FIG. 7 is a schematic diagram of a hardware logic architecture of the controller of FIG. 5, according to some embodiments.

### DETAILED DESCRIPTION

Following below are more detailed descriptions of various concepts related to, and implementations of, methods, apparatuses, and systems for hardware protection logic for power electronics. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the figures generally, the various embodiments disclosed herein relate to systems, apparatuses, and methods for protecting power electronics of a hotel load converter (HLC). A software based protection algorithm can be used when abnormal current and/or voltage are below a hardware power threshold for less than a predetermined hardware time threshold. If the current and/or voltage is higher than the hardware power threshold or the current and/or voltage have been abnormal for longer than the hardware time threshold, then a hardware protection logic is activated. The hardware protection logic protects power electronics components of an inverter and a converter in case of transient and/or abnormal operating condition by re-acting within a few micro-seconds.

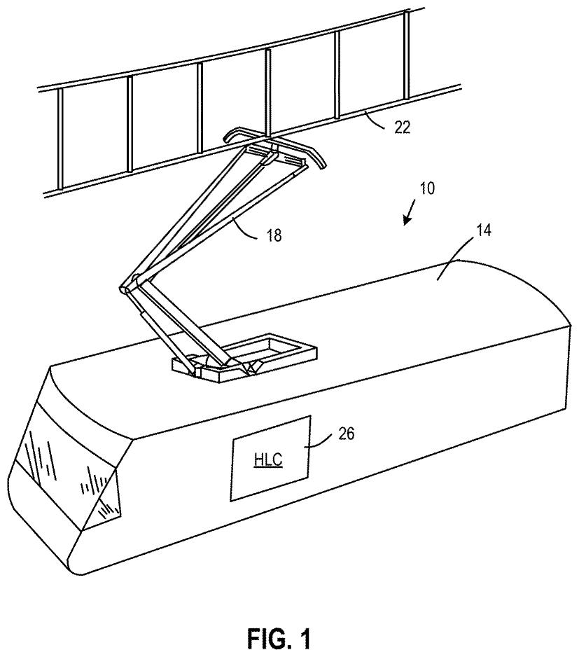

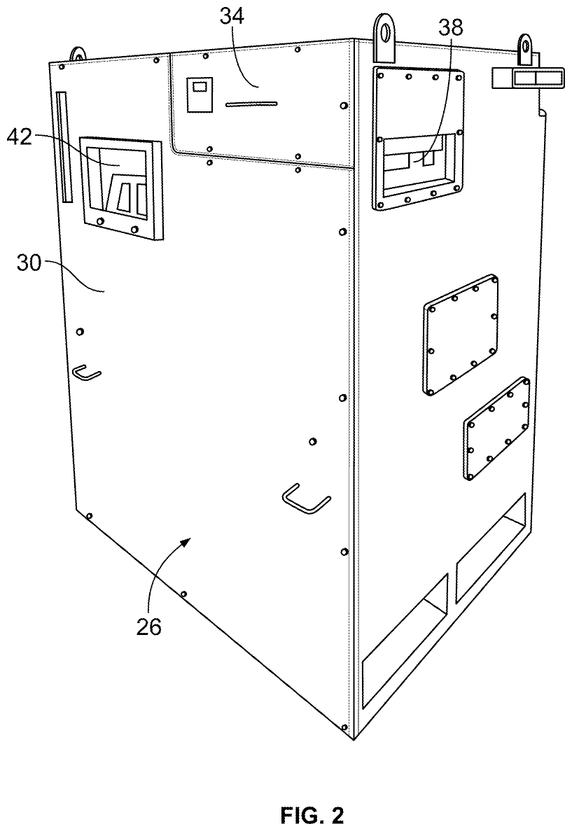

As shown in FIG. 1, a railway car 10 includes a body 14 that supports a pantograph 18. The pantograph 18 includes a set of articulated arms fixed to the body 14 (e.g., a roof) of the railway car 10 that unfold and extend along a vertical axis. A head of the pantograph 18 is fitted with carbon strips structured to engage a contact wire 22. The number and types of carbon strips can be adjusted based on the nature and intensity of the current to be transmitted (e.g., AC or DC). The pantograph 18 transmits power from the contact wire 22 to traction motors and a Hotel Load Converter (HLC) 26.

The HLC 26 is a 500 KW high voltage high power AC to AC converter which has two stages. A first stage converts AC to DC power, and a second stage converts the DC power received from the first stage to three phase AC power. Both the first stage and the second stage include power electronics modules which consists of high power high current insulated-gate bipolar transistor (IGBT) modules, high power bulk capacitors, current and voltages sensors, power electronics, and control boards. The HLC 26 is generally structured to receive power from the pantograph 18 and condition the power for use on the railway car 10 other than to drive the traction motors. For example, the HLC 26 may provide power to climate control (e.g., HVAC), kitchen, washing machines, entertainment systems, lighting, refrigeration systems, water heating systems, etc.

As shown in FIG. 2, the HLC 26 includes a frame 30 structured to support a controller 34 that controls operation of the HLC 26, a connector 38 that provides power from the HLC 26 to external systems of the railway car 10, and a human machine interface (HMI) 42 that allows an operator to interact with the HLC 26.

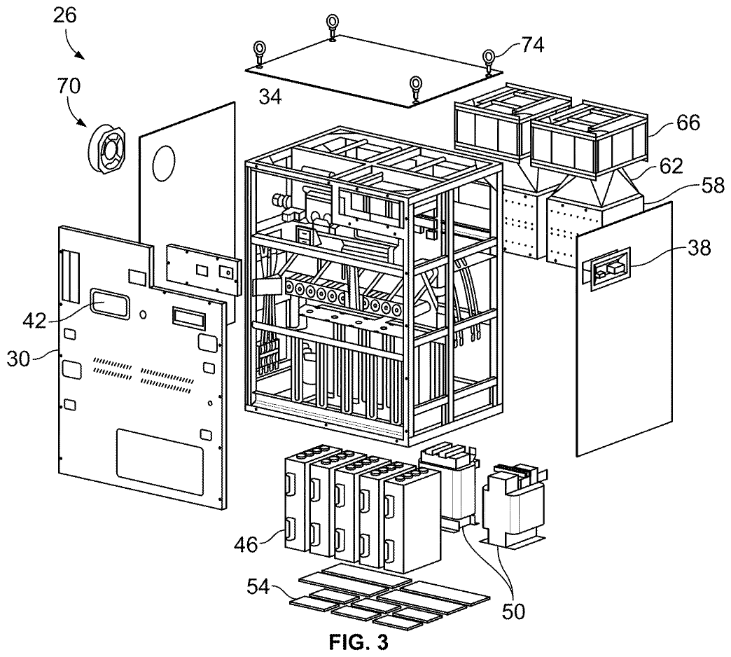

As shown in FIG. 3, the HLC 26 also includes a capacitor bank 46 and inductors 50 supported by bottom plates 54, and a cooling system for the capacitor bank 46 and inductors 50 that includes heat sinks 58, ducts 62, and blowers 66. The HLC 26 also includes a fan 70 for venting the HLC 26 and lifting hooks 74 that facilitate moving the HLC 26. In some embodiments, a different number of capacitors or inductors may be included. Similarly, the number and arrangement of heat sinks 58, ducts 62, and blowers 66 may be adjusted, as desired.

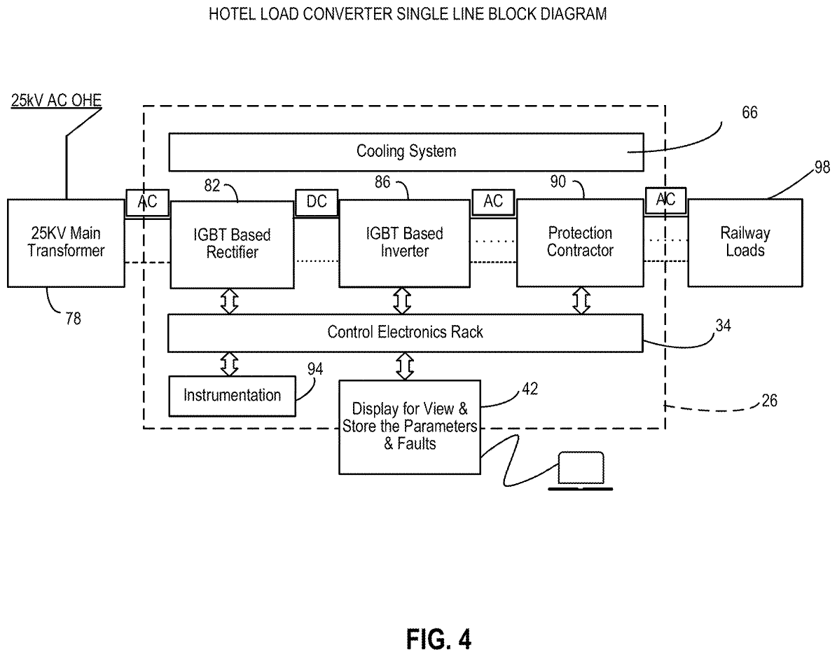

As shown in FIG. 4, the pantograph 18 provides power to a main transformer 78 of the railway car 10 and AC power is provided to the HLC 26. A rectifier 82 receives the AC power from the main transformer 78 and provides DC power to an inverter 86. The inverter 86 converts the DC from the rectifier 82 to three-phase AC power that is provided to a protection contactor 90. The protection contactor 90 is arranged in communication with loads 98 via the connector 38. The controller 34 communicates with and controls the rectifier 82, the inverter 86, and the protection contactor 90. The HLC 26 additionally includes instrumentation (e.g., sensors, shunts, actuators, switches, etc.) in communication with the controller 34. The HMI 42 provides a display and user interface for interaction with the controller 34. In some embodiments, the HMI 42 includes a network connection such as a modem, a network switch, a wireless network, a cloud based service accessible by an application, or another interface, as desired.

In some embodiments, an input voltage received by the rectifier 82 defines a minimum voltage of 633 VAC, a nominal voltage of 960 VAC, and a maximum voltage of 1190 VAC. In some embodiments, a DC bus voltage output by the rectifier 82 is desirably 1800 VDC. In some embodiments, a line voltage per phase of the three-phase AC output from the inverter 86 is 750 Vrms. In some embodiments, a frequency output of the inverter 86 is 50 Hz. In some embodiments, a voltage output of the inverter 86 is 500 KVA.

The power system components of the HLC 26 need to be protected from various faults to ensure reliability and durability of equipment, and to ensure interruption free operation of the HLC 26. Exemplary faults include Input AC Current faults, Input AC Voltage faults, Output DC Voltage faults, Output DC current fault, Output AC current (for each three phases) faults, Output AC voltage (for each three phases) faults, Input Earth faults, Output Earth faults, 110V Battery faults, Rectifier Gate faults, and Inverter Gate faults. In some embodiments, some of the listed faults are eliminated from protection schemes. In some embodiments, other faults may be detected and protected against.

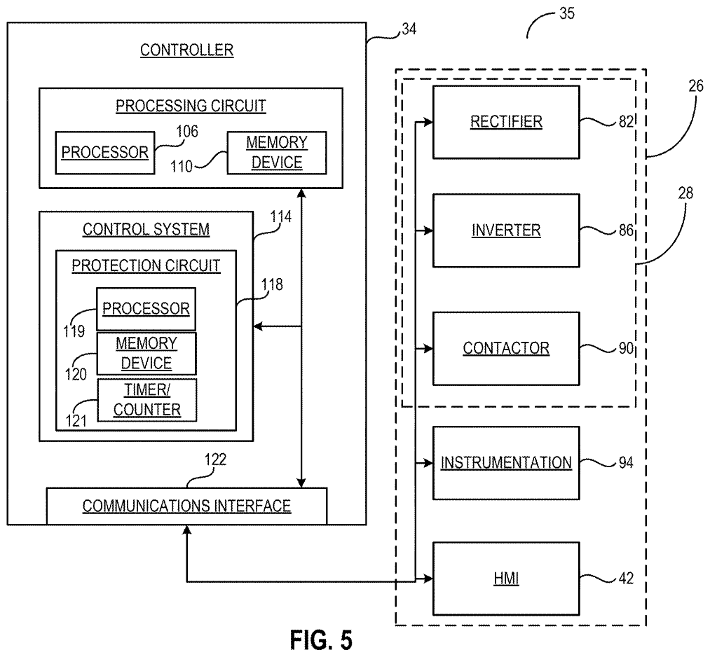

As the components of FIG. 1 are shown to be embodied in the railway car 10, the controller 34 may be separate from or included with at least one railway car controllers located outside the HLC 26. The function and structure of the controller 34 is described in greater detail in FIG. 5.

Referring now to FIG. 5, a schematic diagram of a system 35 for protecting in power electronics is shown. The system 35 may include the controller 34 of the railway car 10 and the HLC 26 of FIG. 1. As shown, the controller 34 includes a processing circuit 102 having a processor 106 and a memory device 110, a control system 114 having a protection circuit 118, and a communications interface 122. The protection circuit 118 may include at least one or processor 119, at least one memory device 120, and at least one timer 121 (or counter), among others. The controller 34 may be structured to be coupled with the HLC 26. The HLC 26 may include a set of power electronic components 26 (e.g., the rectifier 82, the inverter 86, or the contactor 90), the instrumentation 94, and HMI 42, among others. The communication interface 122 may communicate or exchange data with one or more components of the HLC 26, such as the rectifier 82, the inverter 86, the contactor 90, the instrumentation 94, and the HMI 42, among others. Generally, the controller 34 is structured to implement software fault protections and to implement hardware protection logic to provide protection to electronic power systems of the HLC 26.

In one configuration, the protection circuit 118 are embodied as machine or computer-readable media that is executable by a processor, such as processor 119. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the protection circuit 118 are embodied as hardware units, such as electronic control units. As such, the protection circuit 118 may be embodied as one or more circuitry components including, but not limited to, processing circuitry, network interfaces, peripheral devices, input devices, output devices, sensors, etc. In some embodiments, the protection circuit 118 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the protection circuit 118 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The timer 121 of the protection circuit 118 may be implemented using any one or more of the circuitry components detailed herein. The protection circuit 118 may also include programmable hardware devices such as field programmable gate arrays, programmable array logic, programmable logic devices or the like.

The protection circuit 118 may include one or more memory devices for storing instructions that are executable by the processor(s) of the protection circuit 118. The one or more memory devices and processor(s) may have the same definition as provided below with respect to the memory device 120 and processor 119. In some hardware unit configurations, the protection circuit 118 may be geographically dispersed throughout separate locations in the vehicle (e.g., railway car). Alternatively and as shown, the protection circuit 118 may be embodied in or within a single unit/housing, which is shown as the controller 34.

In the example shown, the controller 34 includes the processing circuit 102 having the processor 106 and the memory device 110. The processing circuit 102 may be structured or configured to execute or implement the instructions, commands, and/or control processes described herein with respect to protection circuit 118. The depicted configuration represents the protection circuit 118 as machine or computer-readable media. However, as mentioned above, this illustration is not meant to be limiting as the present disclosure contemplates other embodiments where the protection circuit 118, or at least one circuit of the protection circuit 118, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 106 or 119) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., protection circuit 118 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 110 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 110 may be communicably connected to the processor 106 to provide computer code or instructions to the processor 106 for executing at least some of the processes described herein. Moreover, the memory device 110 may be or include tangible, non-transient volatile memory or non-volatile memory. Accordingly, the memory device 110 may include database components, object code components, script components, or any other type of information structure for supporting the various activities and information structures described herein. The protection circuit 118 (or the control system 114 of which the bounce circuit 118 is a part of or the controller 34) is structured to implement a logic as described below.

The protection circuit 118 is structured to monitor parameters (e.g., frequencies, currents, and/or voltages) of the rectifier 82, the inverter 86, the contactor 90, and/or other components of the HLC 26 using the instrumentation 94. The protection circuit 118 compares the monitored parameters to thresholds or ranges and determines if an operational abnormality exists. For example, if a voltage, current, or frequency is operating out of range, the protection circuit 118 will determine an abnormality. If an abnormality is determined to exist, the protection circuit 118 will determine if the severity of the abnormality falls below a hardware threshold. If the abnormality is determined to be less than the hardware threshold (e.g., the voltage is below a hardware voltage threshold), then software protections are implemented by the protection circuit 118 and a timer is started (e.g., a counter, a real-time-clock, etc.).

The software protections are implemented by the protection circuit 118 for a predetermined time. If the abnormality is corrected within the predetermined time, the software protection is successful and normal operation of the HLC 26 can continue. If, however, the abnormality is not corrected within the predetermined time, or if the severity of the abnormality becomes greater than the hardware threshold (e.g., the voltage exceeds the hardware voltage threshold before the predetermined time has elapsed), then the protection circuit 118 activates a hardware protection logic and the HLC 26 is rapidly protected against the fault and/or abnormality.

The software protection implemented by the protection circuit 118 defines a response time and a fault latched response time of between about 40 uS and about 20 mS. The hardware protection logic defines a response time and a fault latched response time of less than about 1 uS. The hardware protection logic is structural and does not depend on software processing to achieve latching. In other words, the hardware protection logic does not have built in delays for fault scanning and/or processing and therefore provides exceptionally fast response times. The software protection and the hardware protection logic of the protection circuit 118 provide redundancy protection for the HLC 26 power electronics.

The controller 34 may monitor parameters including frequencies, currents, and voltages of power electronics components of the HLC 26 (e.g., any one or more of the rectifier 82, the inverter 86, or the contactor 90). The parameters are then compared to a normal operating threshold or a normal operating threshold range. If then parameters are less than the normal operating threshold or within the normal operating threshold range, then normal operation of the HLC 26 continues and the protection circuit 118 continues to monitor parameters. The normal operating threshold and/or normal operating threshold range define a limit for voltage and/or currents when the power electronics operate under normal operating conditions (e.g., no fault conditions exist).

If the parameters are determined to be greater than the normal threshold or outside the normal threshold range, then the parameters are compared to a hardware threshold or a hardware threshold range. The hardware threshold and/or the hardware threshold range define a limit for voltages and/or currents over which the power electronics can withstand only a short duration of operation (e.g., a few hundreds of uS to a few hundred mS) before catastrophic failure.

If the parameters are less than the hardware threshold, a timer is activated (e.g., a counter started, a time-stamp created based on a real-time-clock, etc.). If a timer value is less than a software protection time threshold, the protection circuit 118 activates software protection of the HLC 26. During software protection, the protection circuit 118 continues to compare the parameters to the hardware threshold. If the parameters become greater than the hardware threshold or the timer exceeds the software protection time, the protection circuit 118 immediately activates the hardware protection logic to rapidly protect the HLC 26. Once the current and/or voltage crosses the hardware threshold the hardware protection logic turns off the power electronics within a few microseconds (uS) to inhibit catastrophic failure of the power electronics. In some embodiments, the hardware control logic also provides an interrupt for micro-controller fault recognition.

The protection circuit 118 is one example of a power electronics protection system including one or more processing circuits including one or more memory devices coupled to one or more processors, the one or more memory devices configured to store instructions thereon that, when executed by the one or more processors, cause the one or more processors to: monitor power electronics parameters, compare the parameters to a hardware protection threshold, activate software protection of the power electronics when the parameters are less than the hardware protection threshold, and activate hardware protection logic of the power electronics when the parameters are greater than or equal to the hardware protection threshold.

The one or more memory devices are further configured to store instructions thereon that, when executed by the one or more processors, cause the one or more processors to compare the parameters to a normal operation threshold, and activate the software protection of the power electronics when the parameters are greater than the normal operation threshold and less than the hardware protection threshold. The one or more memory devices are further configured to store instructions thereon that, when executed by the one or more processors, cause the one or more processors to: start a timer when the software protection is activated, compare the timer to a software protection time threshold, and activate the hardware protection logic of the power electronics when the timer is greater than the software protection time threshold.

In some embodiments, the system 35 may include the HLC 26. The HLC 26 may include a power electronic component (e.g., the rectifier 82) to perform alternating current to alternating current to alternating current (AC/AC) conversion on electric power to provide to a load on a railway car. The system 35 may include the controller structured to be coupled with the HLC. The controller 34 may include a protection circuit 118. The controller 34 may monitor a parameter of the power electronic component of the HLC 26. The controller 34 may determine that the parameter fails to satisfy a normal threshold defining a first limit for the parameter corresponding to no fault condition in the power electronic component. The controller 34 may determine that the parameter fails to satisfy a hardware threshold defining a second limit for the parameter corresponding to prior to failure of the power electronic component. The controller 34 may activate hardware protection for the power electronic component of the HLC 26, responsive to determining that the parameter fails to satisfy the normal threshold and the hardware threshold.

In some embodiments, the controller 34 may start a timer 121, responsive to determining that the parameter satisfies the hardware threshold. The controller 34 may activate software protection for the power electronic component of the HLC 26, while the timer 121 is below a time threshold. In some embodiments, the controller 34 may start a timer 121 while software protection is activated for the power electronic component, responsive to determining that the parameter satisfies the hardware threshold. In some embodiments, the controller 34 may activate the hardware protection, responsive to the timer 121 exceeding a time threshold for the software protection.

In some embodiments, the controller 34 may activate the hardware protection by disconnecting or interrupting the power electronic component of the HLC 26 for a period of time. In some embodiments, the controller 34 may continue to monitor the parameter of the power electronic component of the HLC 26, responsive to determining that the parameter satisfies the normal threshold. In some embodiments, the controller 34 may receive the electric power delivered via a pantograph from a contact wire from outside the railway car. In some embodiments, the controller 34 may provide the electric power to the load on the railway car. The load may include at least one of: an entertainment system, a kitchen appliance, a refrigeration system, or a heating system for the railway car.

At least one aspect of the present disclosure is directed to a controller. The controller 34 may include protection circuit 118 comprising one or more processors 119 coupled with memory 120. The protection circuit 118 may monitor a parameter of a power electronic component of the HLC 26 conveying electric power from outside a railway car to a load within the railway car. The protection circuit 118 may compare the parameter of the power electronic component with a normal threshold to identify an existence of a fault condition. The protection circuit 118 may compare the parameter of the power electronic component with a hardware threshold. The protection circuit 118 may activate at least one of software protection or hardware protection for the power electronic component of the HLC 26, based on a comparison between the parameter with the normal threshold and a comparison between the parameter with the hardware threshold.

In some embodiments, the protection circuit 118 may monitor a plurality of parameters comprising at least one of: a voltage, a current, or a frequency of the electric power conveyed through the HLC 26. In some embodiments, the protection circuit 118 may compare the plurality of parameters with a corresponding plurality of thresholds to determine whether to activate one of the software protection or the hardware protection.

In some embodiments, the protection circuit 118 may activate a counter 121, responsive to determining that the parameter satisfies the hardware threshold. In some embodiments, the activate the software protection for the power electronic component of the converter, while a value of the counter 121 is less than a software protection threshold.

In some embodiments, the protection circuit 118 may activate a counter 121 while software protection is activated for the power electronic component, responsive to determining that the parameter satisfies the hardware threshold. In some embodiments, the protection circuit 118 may switch from the software protection to the hardware protection, responsive to a value of the counter 121 exceeding a software protection threshold.

In some embodiments, the protection circuit 118 may identify a lack of abnormal operating condition in the power electronic component of the HLC 26, responsive to determining that the parameter satisfies the normal threshold. In some embodiments, the protection circuit 118 may continue to monitor the parameter of the power electronic component, in response to identifying the lack of abnormal operating condition.

In some embodiments, the protection circuit 118 may identify the existence of abnormal operating condition in the power electronic component of the HLC 26, responsive to determining that the parameter fails to satisfy the normal threshold. In some embodiments, the protection circuit 118 may determine whether to activate one of the one of the software protection or the hardware protection based on a severity of the abnormal operating condition. In some embodiments, the one or more processors 119 and memory 120 of the protection circuit 118 may be disposed in the railway car with the HLC 26.

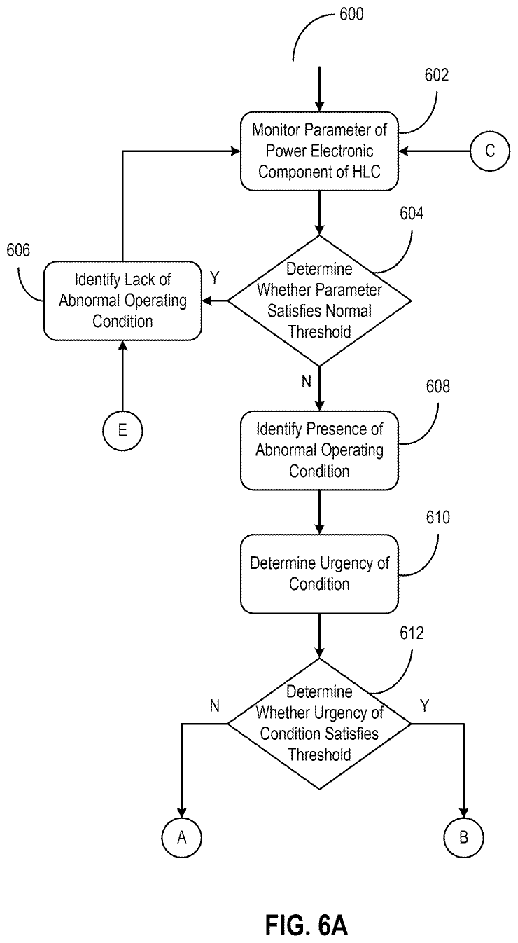

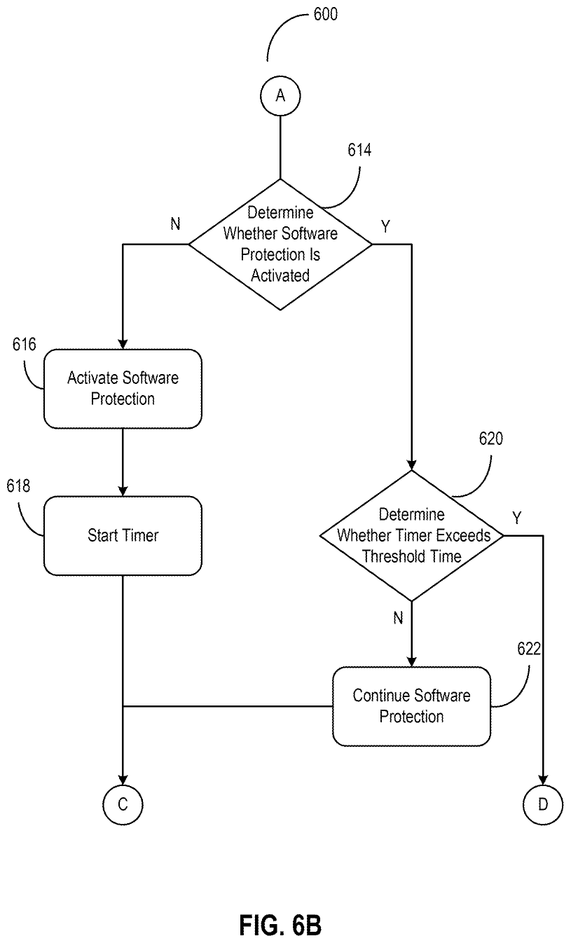

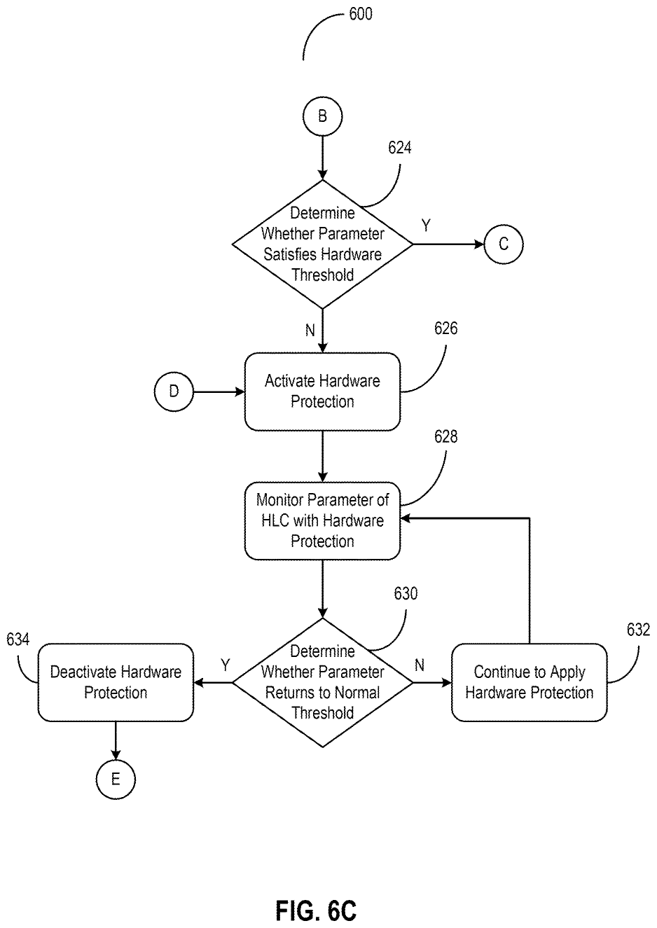

Referring now to FIGS. 6A-C, depicted is a flow diagram of a method 600 of protecting power electronics. The method 600 may be implemented or performed using any of the components described herein, such as the controller 34, the protection circuit 118, and the HLC 26 of the system 35. The method 600 may omit or skip one or more of the steps described herein. Under the method 600, at step 602, a controller (e.g., the controller 34) may identify, measure, or otherwise monitor a parameter of at least one power electronic component (e.g., the rectifier 82, the inverter 86, or the contactor 88) of a hotel load converter (e.g., the HLC 26). The HLC may accept or receive the electric power delivered via a pantograph from a contact wire from outside the railway car. In some embodiments, the controller may monitor a set of parameters of the power electronic component in the HLC. The parameters may define or identify characteristics of electrical power conveyed from a source outside the railway car to a load within the railway car via the HLC. The parameter may include at least one of: a voltage, a current, or a frequency of the electrical power conveyed through the HLC. In some embodiments, the controller may measure the parameter at an input of the power electronic component of the HLC.

At step 604, the controller may identify or determine whether the parameter satisfies a normal threshold (sometimes herein referred to as a software threshold). The normal threshold may delineate, define, or otherwise identify a value at which to trigger or activate software protection for the power electronic component of the HLC. In some embodiments, the normal threshold may identify define a first limit for the parameter corresponding to a no fault condition in the power electronic component. In some embodiments, the normal threshold may be used to identify an existence of an abnormal operating condition (also sometimes referred herein as a fault condition or an anomaly condition) in the power electronic.

In some embodiments, the controller may determine the set of parameters with a corresponding set of normal thresholds. For each parameter, the controller may compare the parameter with the corresponding threshold. The value of the normal threshold may be dependent on the type of parameter (e.g., voltage, current, or frequency) to which the threshold is compared. In determining, the controller may compare the parameter with the normal threshold. When the parameter is less than the normal threshold, the controller may determine that the parameter satisfies the normal threshold. Conversely, when the parameter is greater than or equal to the threshold, the controller may determine that the parameter fails to satisfy the normal threshold.

At step 606, if the parameter is determined to satisfy the normal threshold, the controller may determine, detect, or otherwise identify a lack of an abnormal operation condition (or fault condition). The lack of the abnormal operation condition may correspond to when the power electronic component of the HLC is in a healthy or normal state providing electrical power from outside the railway car to loads within the railway car. The loads within the railway car may include, for example, at least one of: an entertainment system, a personal electronic device, a kitchen appliance, a refrigeration system, or a heating system for the railway car. In some embodiments, the loads may include propulsion components within the railway car. The load within the railway car may be electrically coupled with the HLC. Upon identification of the lack of the abnormal operation condition, the controller may continue the method 600 from step 602, and may continue to monitor the parameter of the power electronic component of the HLC. In some embodiments, if the software activation was activated, the controller may disable, turn off, or otherwise deactivate the software protection.

At step 608, if the parameter is determined to fail to satisfy the normal threshold, the controller may determine, detect, or otherwise identify a presence of an abnormal operating condition. The presence of the abnormal operating condition may correspond to when the power electronic component of the HLC is in an unhealthy or fault state (e.g., unwanted shutdowns or trips). The abnormal operating condition may also correspond to the state of the power electronic component at a point of failure (e.g., due to more severe events). The controller may provide countermeasures to address the abnormal operating condition using software protection or hardware protection as detailed herein.

At step 610, the controller may identify or determine an urgency of addressing the abnormal operating condition. The urgency may identify, indicate, or otherwise define a degree (e.g., a numerical value or score) of importance at which the abnormal operating condition in the power electronic component in the HLC should be addressed. For instance, the urgency may be determined as a function of the value of the voltage, current, or frequency, or any combination thereof. In some embodiments, the controller may calculate, identify, or otherwise determine a severity of the abnormal operating condition based on the parameter. The severity may identify, indicate, or otherwise define a level of seriousness (e.g., a numerical value or score) of the abnormal operating condition in the power electronic component in the HLC. For example, the severity may be determined as a function of the value of the voltage, current, or frequency, or type of abnormal operating condition, or any combination thereof. In some embodiments, the method 600 may omit step 610.

At step 612, the controller may identify or determine whether the urgency of addressing the abnormal operating condition satisfies a threshold. The controller may compare the urgency of addressing the condition with the threshold to determine whether to trigger or activate at least one of software protection or hardware protection of the power electronic component of the HLC. The threshold may delineate, identify, or otherwise define a value for the urgency at which to activate at least one of the software protection or hardware protection. When the urgency is greater than or equal to the threshold, the controller may determine that the urgency satisfies the threshold. The controller may determine to trigger or activate the hardware protection. Conversely, when the urgency is less than the threshold, the controller may determine that the urgency fails to satisfy the threshold. The controller may also determine to trigger or activate the software protection. In some embodiments, the method 600 may omit step 612.

In some embodiments, the controller may identify or determine whether the severity of abnormal operating condition satisfies a threshold. The controller may compare the severity of addressing the condition with the threshold to determine whether to trigger or activate at least one of software protection or hardware protection of the power electronic component of the HLC. The threshold may delineate, identify, or otherwise define a value for the severity at which to activate at least one of the software protection or hardware protection. When the severity is greater than or equal to the threshold, the controller may determine that the severity fails to satisfy the threshold. The controller may determine to trigger or activate the hardware protection. Conversely, when the severity is less than the threshold, the controller may determine that the severity satisfies the threshold. The controller may also determine to trigger or activate the software protection.

At step 614, if the urgency is determined to not satisfy (e.g., less than) the threshold, the controller may identify or determine whether software protection is activated. In some embodiments, if the severity is determined to satisfy (e.g., less than) the threshold, the controller may determine whether the software protection is activated. The controller may identify an activation status of the software protection on the power electronic component on the HLC. When the status indicates that the software protection is activated, the controller may determine that the software protection is activated. On other hand, when the status indicates that the software protection is not activated, the controller may determine that the software protection is not activated. In some embodiments, the method 600 may omit step 614.

At step 616, if the software protection is determined to be not activated, the controller may enable, apply, or otherwise activate the software protection on the power electronic component of the HLC. In some embodiments, the controller may activate the software protection, when the parameter of the power electronic component is determined to fail to satisfy the normal threshold. The software protection may be provided on the power electronic component via a computer readable instruction stored on the protection circuit of the controller. The software protection may include, for example: over-voltage protection, over-current protection, and isolation of shutdown, faults, or trips, among others, on the rectifier or inverter and other power electronic components of the HLC. The software protection may have a lower response time than the hardware protection. In some embodiments, the controller may keep or maintain the application of the software protection, while the hardware protection is deactivated.

In some embodiments, the method 600 may include activating, by the controller, software protection for the power electronic component of the HLC, responsive to determining that the parameter fails to satisfy the normal threshold. In some embodiments, the method 600 may include monitoring, by the controller, a second parameter of the power electronic component, while software protection is activated for the power electronic component. In some embodiments, the method 600 may include deactivating, by the controller, the software protection, responsive to the second parameter satisfying the normal threshold within a time threshold.

At step 618, the controller may turn on, activate, or otherwise start a timer or counter (e.g., the timer 121). The timer (or counter) may be activated, when the parameter of the power electronic component is determined to satisfy the normal threshold or when the software protection is activated. The timer (or counter) may maintain or keep track of an amount of time that the software protection is applied on the power electronic component of the HLC. In some embodiments, the timer may be started and maintained by the controller while the software protection is activated for the power electronic component. The controller may maintain or continue activation of the software protection while the timer is below a time threshold. With the start of the timer, the controller continue the method 600 from step 602, and may continue to monitor the parameter of the power electronic component of the HLC, while the software protection is activate and being applied. In some embodiments, if subsequently the parameter of the power electronic component satisfies the normal threshold, the controller may disable, turn off, or otherwise deactivate the software protection.

At step 620, if the software protection is determined to be activated, the controller may identify or determine whether the timer exceeds a threshold time. From the timer (or counter), the controller may measure, determine, or otherwise identify the amount of time that the software protection is applied on the power electronic component of the HLC. With the identification, the controller may compare the timer with the threshold time. The threshold time may delineate, identify, or otherwise define a value for the amount of time during which the software protection is expected to resolve the abnormal operating condition. In some embodiments, the threshold time may define the value of the amount of time at which to trigger the hardware protection or switch from the software protection to the hardware protection. When the time of the timer is greater than the threshold time, the controller may determine that the timer exceeds the threshold time. The controller may also determine to activate the hardware protection or switch from the software protection to the hardware protection, and may continue the method 600 from step 626. Otherwise, when the time of the timer is less than or equal to the threshold time, the controller may determine that the timer does not exceed the threshold time.

At step 622, if the timer is determined to not exceed the threshold time, the controller may continue applying the software protection. The controller may use the timer (or the counter) continue to maintain the amount of time that the software protection is active for the power electronic component of the HLC. In addition, the controller continue the method 600 from step 602, and may continue to monitor the parameter of the power electronic component of the HLC. In some embodiments, if subsequently the parameter of the power electronic component satisfies the normal threshold within the threshold time, the controller may disable, turn off, or otherwise deactivate the software protection.

At step 624, the controller may identify or determine whether the parameter satisfies a hardware threshold. In some embodiments, when the parameter is determined to fail to satisfy the normal threshold, the controller may determine whether the parameter of the power electronic component satisfy the hardware threshold. In some embodiment, when the urgency satisfies the threshold, the controller may omit or skip the determination of whether the parameter satisfies the hardware threshold. In some embodiments, when the severity of the abnormal operating condition fails to satisfy the threshold, the controller may determine whether the parameter satisfies the hardware threshold.

In determining, the controller may compare the parameter of the power electronic components with the hardware threshold. The hardware threshold may delineate, define, or otherwise identify a value at which to trigger or activate hardware protection for the power electronic component of the HLC or switch from the software protection to activate the hardware protection. In some embodiments, the hardware threshold may identify define a second limit for the parameter corresponding to prior (e.g., within a time limit ranging from picoseconds to fractions of a section) to failure of the power electronic component. In some embodiments, the hardware threshold may be used to identify an existence of an abnormal operating condition (also sometimes referred herein as a fault condition or an anomaly condition) in the power electronic.

In some embodiments, the controller may determine the set of parameters with a corresponding set of hardware thresholds. For each parameter, the controller may compare the parameter with the corresponding threshold. The value of the hardware threshold may be dependent on the type of parameter (e.g., voltage, current, or frequency) to which the threshold is compared. In some embodiments, the controller may compare the parameter with the hardware threshold. When the parameter is less than the hardware threshold, the controller may determine that the parameter satisfies the hardware threshold. In addition, the controller may continue the method 600 from step 602, and may continue to monitor the parameter of the power electronic component of the HLC, while the software protection is activate and being applied. Conversely, when the parameter is greater than or equal to the hardware threshold, the controller may determine that the parameter fails to satisfy the hardware threshold.

At step 626, if the parameter fails to satisfy the hardware threshold, the controller may enable, apply, or otherwise activate the hardware protection on the power electronic component of the HLC. The hardware protection may be provided via components (e.g., logic circuitry or other protective circuitry) in the power electronics components of the HLC. The components used to apply hardware protection may include, for example: fuses, circuit breakers, surge suppressors, current limiters, voltage limiters, transformers, or a reverse polarity protection circuit, among others. In applying the hardware protection, the controller may disconnect or interrupt the flow of electrical power through the power electronic component of the HLC for a period of time (e.g., using the components).

In some embodiments, the controller may activate the hardware protection, when the parameter of the power electronic component is determined to fail to satisfy the normal threshold and the hardware threshold. In some embodiments, the controller may activate the hardware protection, when the urgency of addressing the condition satisfies the condition. In some embodiments, the controller may activate the hardware protection, when the timer exceeds the threshold time for the software protection. In some embodiments, the controller may switch from the software protection to the hardware protection by deactivating the software protection and activating the hardware protection.

In some embodiments, the method 600 may include monitoring, by a controller, a parameter of a power electronic component of a hotel load converter (HLC). The method 600 may include determining, by the controller, that the parameter fails to satisfy a normal threshold for the parameter corresponding to no fault condition in the power electronic component. The method 600 may include determining, by the controller, that the parameter fails to satisfy a hardware threshold for the parameter corresponding to prior to failure of the power electronic component. The method 600 may include activating, by the controller, hardware protection for the power electronic component of the HLC, responsive to determining that the parameter fails to satisfy the normal threshold and the hardware threshold.

In some embodiments, the method 600 may include monitoring, by the controller, a second parameter of the power electronic component, while software protection is activated for the power electronic component. In some embodiments, activating the hardware protection may include switching from software protection to the hardware protection, responsive to the second parameter failing to satisfy the hardware threshold within a time threshold.

In some embodiments, the method 600 may include maintaining, by the controller, activation of the software protection for the power electronic component of the HLC, while the hardware protection is deactivated. In some embodiments, the method 600 may include determining, by the controller, that a an urgency of addressing an abnormal operating condition in the power electronic of the HLC satisfies a condition to activate the hardware protection. In some embodiments, the method 600 may include activating the hardware protection further comprises activating the hardware protection for the power electronic component of the HLC, responsive to determining that the urgency of addressing the abnormal operating condition satisfies the condition.

At step 628, the controller may identify, measure, or otherwise monitor a parameter of at least one power electronic component of the HLC, while the hardware protection is being applied. Step 628 may be similar to the functionalities under step 602. In some embodiments, the controller may monitor a set of parameters of the power electronic component in the HLC, while the hardware protection is being applied. The parameters may define or identify characteristics of electrical power conveyed from a source outside the railway car to a load within the railway car via the HLC. The parameter may include at least one of: a voltage, a current, or a frequency of the electrical power conveyed through the HLC. In some embodiments, the controller may measure the parameter at an input of the power electronic component of the HLC, as the hardware protection is being applied.

At step 630, the controller may identify or determine whether the parameter has returned to within the normal threshold (or within the hardware threshold). In some embodiments, the controller may identify or determine whether the parameter satisfies the normal threshold, as the hardware protection is being applied. In some embodiments, the controller may determine the set of parameters with a corresponding set of normal thresholds. For each parameter, the controller may compare the parameter with the corresponding threshold. The value of the normal threshold may be dependent on the type of parameter (e.g., voltage, current, or frequency) to which the threshold is compared.

In determining, the controller may compare the parameter with the normal threshold (or the hardware threshold). When the parameter is less than the normal threshold, the controller may determine that the parameter has returned to within and satisfy the normal threshold. At step 632, if the parameter has not returned to within the normal threshold, the controller may continue to apply the hardware protection. The controller may maintain the activation of the hardware protection on the power electronic component of the HLC. The controller may continue the method 600 from step 628, and may continue to monitor the parameter of the power electronic component of the HLC.

Conversely, when the parameter is greater than or equal to the threshold, the controller may determine that the parameter fails to satisfy the normal threshold and has not returned to within the normal threshold. At step 634, if the parameter has returned to within the normal threshold, the controller may disable, cease applying, or otherwise deactivate the hardware protection. The controller may continue the method 600 from step 606, and if the parameter has returned to within the normal threshold, the controller may identify the resolution or the lack of the abnormal operating condition of the power electronic component of the HLC.

In some embodiments, the method 600 may include monitoring, by the controller, a second parameter of the power electronic component, while the hardware protection is activated. In some embodiments, the method 600 may include switching, by the controller, from the hardware protection to software protection for the power electronic component of the HLC responsive to determining that the second parameter satisfies the normal threshold and the hardware threshold.

In some embodiments, if the parameter has returned to within the hardware threshold (but outside the normal threshold), the controller may switch from the hardware protection to the software protection. The controller may perform the switch by deactivating the hardware protection and by activating the software protection, and may continue the method 600 from step 602, and may continue to monitor the parameter of the power electronic component in the HLC.

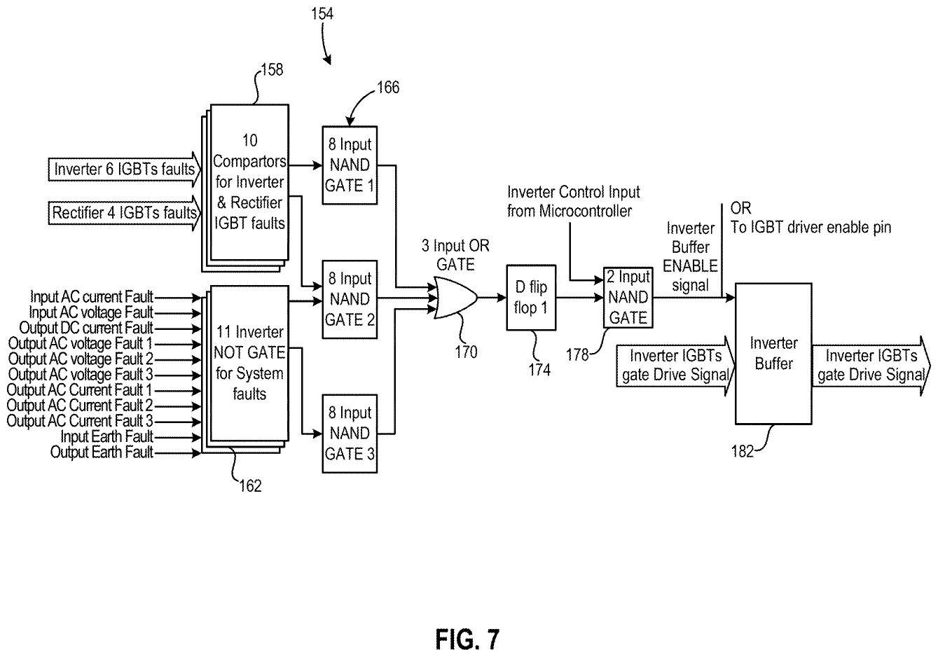

As shown in FIG. 7, a hardware protection logic 154 includes a comparator stack 158 that receives inputs from IGBT drivers. In some embodiments, the comparator stack 158 receives six IGBT fault status codes from the inverter 86 and four IGBT fault status codes from the rectifier 82. In some embodiments, a different number of IGBT fault status codes are received.

A NOT gate 162 is structured to receive Input AC Current faults, Input AC Voltage faults, Output DC current fault, Output AC current (for each three phases) faults, Output AC voltage (for each three phases) faults, Input Earth faults, and Output Earth faults. In some embodiments, other parameters and/or faults are considered, as desired.

Outputs from the comparator stack 158 and the NOT gate 162 include a binary output (e.g., high or low). In some embodiments, if a fault exists in the comparator stack 158 inputs, a low output will be provided (e.g., indicating a fault has occurred). In some embodiments, if a fault exists in the NOT gate 162 inputs, a low output will be provided (e.g., indicating a fault has occurred). In some embodiments, a fault may be identified by a high output or another control output, as desired.

The outputs from the comparator stack 158 and the NOT gate 162 are provided to a NAND gate stage 166 where all outputs from the comparator stack 158 and the NOT gate 162 are processed. If a fault exists, the NAND gate stage 166 receives the low output from the comparator stack 158 and/or the NOT gate 162, then the NAND gate stage 166 outputs a high output.

The NAND gate stage 166 then provides an output to an OR gate stage 170. The OR gate stage 170 unifies the outputs of the NAND gate stage 166. If a fault is indicated by any one of operators in the NAND gate stage 166, then the OR gate stage 170 passes through a high output.

A D-flip-flop stage 174 inverts the output from the OR gate stage 170. Therefore is a fault exists, the D-flip-flop stage 174 will receive a high input and provide a low output.

a two-input NAND gate 178 receives the output from the D-flip-flop stage 174 and also receives an inverter control input from the controller 34. If the two-input NAND gate 178 receives a low signal indicating a fault was detected from the D-flip-flop stage 174, and the inverter control input does not prohibit shutdown or latching, then the two-input NAND gate 178 outputs a high output to both an control gate 182 and to an IGBT enable pin of the controller 34. The control gate 182 communicates with the rectifier 82 and the inverter 86 to disable the digital buffer states and institute protections for the power electronics. The signal flow described above is represented below in Table 1.

TABLE 1
System Fault Signal Processing

| | comparator stack | | | | | | | | two-input | | |
|---|---|---|---|---|---|---|---|---|---|---|---|
| | 158 and the | | NAND gate | | OR gate | | D-flip-flop | | NAND gate | | |
| Operation | NOT gate 162 | | stage 166 | | stage 170 | | stage 174 | | 178 | | control |
| Condition | Input | Output | Input | Output | Input | Output | Input | Output | Input | Output | gate 182 |
| Normal | LOW | HIGH | HIGH | LOW | LOW | LOW | LOW | HIGH | HIGH | LOW | ENABLED |
| Operation | | | | | | | | | | | |
| Fault | HIGH | LOW | LOW | HIGH | HIGH | HIGH | HIGH | LOW | LOW | HIGH | DISABLED |
| Condition | | | | | | | | | | | |

Outputs of the control gate 182 can be defined as shown in Table 2 below.

TABLE 2

Turn Off Required?

| Fault | | No. of | Rectifier | Inverter |
|---|---|---|---|---|
| Condition | State | Faults | PWM | PWM |
| Input AC | Latch | 1 | Y | Y |
| Current | | | | |
| Input AC | Latch | 1 | Y | Y |
| Voltage | | | | |
| Output DC | Hysteresis | 1 | Y | N |
| Voltage | | | | |
| Output DC | Latch | 1 | Y | Y |
| Current | | | | |
| Output AC | Latch | 3 | Y | Y |
| Current | | | | |
| Output AC | Latch | 3 | Y | Y |
| Voltage | | | | |
| Input Earth | Latch | 1 | Y | Y |
| Output Earth | Latch | 1 | Y | Y |
| 110 V Battery | Hysteresis | 0 | NA | NA |
| Rectifier Gate | Latch | 4 | Y | Y |
| Inverter Gate | Latch | 6 | Y | Y |

Some advantages of the protection circuit 118 include: independent functionality of both software protection and hardware protection logic; very fast response time of the hardware protection logic of less than one microsecond (1 uS) (e.g., calculated value=0.6308 uS); all AC and DC current and voltage protections are provided in a single hardware protection logic circuit; latch logic is included in the hardware protection logic to prevent subsequent damage to the HLC 26; the protection circuit 118 includes hysteresis logic for automatic HLC 26 restart once voltage or other parameters return to the normal range; dedicated faults interrupt given to microcontroller to understand and recognize faults; and logic low or logic high configurable faults level in single hardware protection logic circuit.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIGS. 5-7, it should be understood that the controller 34 may include any number of circuits for completing the functions described herein. For example, the activities and functionalities of the protection circuit 118 may be combined in multiple circuits or as a single circuit. Additional circuits with additional functionality may also be included. Further, the controller 34 may further control other activity beyond the scope of the present disclosure.

As mentioned above and in one configuration, the “circuits” may be implemented in machine-readable medium for execution by various types of processors, such as the processor 106 of FIG. 5. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the HLC 26 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A system for hardware protection in power electronics, comprising:
a hotel load converter (HLC) comprising a power electronic component configured to perform alternating current to alternating current (AC/AC) conversion on electric power to provide to a load on a railway car; and
a controller structured to be coupled with the HLC, the controller comprising a protection circuit configured to:
monitor a parameter of the power electronic component of the HLC;
determine that the parameter fails to satisfy a normal threshold defining a first limit for the parameter corresponding to a no-fault condition in the power electronic component;
determine that the parameter fails to satisfy a hardware threshold defining a second limit for the parameter corresponding to a state prior to a failure condition of the power electronic component; and
activate hardware protection for the power electronic component of the HLC, responsive to determining that the parameter fails to satisfy the normal threshold and the hardware threshold.

2. The system of claim 1, wherein the controller is further configured to:
start a timer, responsive to determining that the parameter satisfies the hardware threshold; and
activate software protection for the power electronic component of the HLC, while the timer is below a time threshold.

3. The system of claim 1, wherein the controller is further configured to:
start a timer while software protection is activated for the power electronic component, responsive to determining that the parameter satisfies the hardware threshold; and
activate the hardware protection, responsive to the timer exceeding a time threshold for the software protection.

4. The system of claim 1, wherein the controller is further configured to activate the hardware protection by disconnecting or interrupting the power electronic component of the HLC for a period of time.

5. The system of claim 1, wherein the controller is further configured to continue to monitor the parameter of the power electronic component of the HLC, responsive to determining that the parameter satisfies the normal threshold.

6. The system of claim 1, wherein the HLC is further configured to receive the electric power delivered via a pantograph from a contact wire from outside the railway car.

7. The system of claim 1, wherein the HLC is further configured to provide the electric power to the load on the railway car, wherein the load comprises at least one of: an entertainment system, a kitchen appliance, a refrigeration system, or a heating system for the railway car.

8. A controller, comprising:
a protection circuit comprising one or more processors coupled with memory, the protection circuit configured to:
monitor a parameter of a power electronic component of a hotel load converter (HLC) conveying electric power from outside a railway car to a load within the railway car;
compare the parameter of the power electronic component with a normal threshold to identify an existence of a fault condition;
compare the parameter of the power electronic component with a hardware threshold; and
activate at least one of software protection or hardware protection for the power electronic component of the HLC, based on a comparison between the parameter with the normal threshold and a comparison between the parameter with the hardware threshold.

9. The controller of claim 8, wherein the protection circuit is further configured to:
monitor a plurality of parameters comprising at least one of: a voltage, a current, or a frequency of the electric power conveyed through the HLC; and
compare the plurality of parameters with a corresponding plurality of thresholds to determine whether to activate one of the software protection or the hardware protection.

10. The controller of claim 8, wherein the protection circuit is further configured to:
activate a counter, responsive to determining that the parameter satisfies the hardware threshold; and
activate the software protection for the power electronic component of the hotel load converter, while a value of the counter is less than a software protection threshold.

11. The controller of claim 10, wherein the protection circuit is further configured to:
activate a counter while the software protection is activated for the power electronic component, responsive to determining that the parameter satisfies the hardware threshold; and
switch from the software protection to the hardware protection, responsive to a value of the counter exceeding a software protection threshold.

12. The controller of claim 8, wherein the protection circuit is further configured to:
identify a lack of an abnormal operating condition in the power electronic component of the HLC, responsive to determining that the parameter satisfies the normal threshold; and
continue to monitor the parameter of the power electronic component, in response to identifying the lack of the abnormal operating condition.

13. The controller of claim 12, wherein the protection circuit is further configured to:
identify the existence of the abnormal operating condition in the power electronic component of the HLC, responsive to determining that the parameter fails to satisfy the normal threshold; and
determine whether to activate one of the one of the software protection or the hardware protection based on a severity of the abnormal operating condition.

14. The controller of claim 8, wherein the one or more processors and memory of the protection circuit are disposed in the railway car with the HLC.

15. A method of protecting power electronics, comprising:
monitoring, by a controller, a parameter of a power electronic component of a hotel load converter (HLC);
determining, by the controller, that the parameter fails to satisfy a normal threshold for the parameter corresponding to a no-fault condition in the power electronic component;
determining, by the controller, that the parameter fails to satisfy a hardware threshold for the parameter corresponding to a state prior to a failure of the power electronic component; and
activating, by the controller, hardware protection for the power electronic component of the HLC, responsive to determining that the parameter fails to satisfy the normal threshold and the hardware threshold.

16. The method of claim 15, further comprising:
activating, by the controller, software protection for the power electronic component of the HLC, responsive to determining that the parameter fails to satisfy the normal threshold;
monitoring, by the controller, a second parameter of the power electronic component, while software protection is activated for the power electronic component; and
deactivating, by the controller, the software protection, responsive to the second parameter satisfying the normal threshold within a time threshold.

17. (canceled)

18. (canceled)

19. The method of claim 15, further comprising:
monitoring, by the controller, a second parameter of the power electronic component, while software protection is activated for the power electronic component,
wherein activating the hardware protection further comprises switching from software protection to the hardware protection, responsive to the second parameter failing to satisfy the hardware threshold within a time threshold.

20. The method of claim 19, further comprising:
maintaining, by the controller, activation of the software protection for the power electronic component of the HLC, while the hardware protection is deactivated.

21. The method of claim 15, further comprising:
determining, by the controller, that an urgency of addressing an abnormal operating condition in the power electronic of the HLC satisfies a condition to activate the hardware protection,
wherein activating the hardware protection further comprises activating the hardware protection for the power electronic component of the HLC, responsive to determining that the urgency of addressing the abnormal operating condition satisfies the condition.

22. The method of claim 15, further comprising:
monitoring, by the controller, a second parameter of the power electronic component, while the hardware protection is activated; and
switching, by the controller, from the hardware protection to software protection for the power electronic component of the HLC responsive to determining that the second parameter satisfies the normal threshold and the hardware threshold.
